(19) United States
(12) Patent Application Publication
(10) Pub. No.: US 2014/0317328 A1
(43) Pub. Date: Oct. 23, 2014

(54) SERIAL ATTACHED SCSI EXPANDER AND INTERFACE EXPANDING DEVICE WITH THE SAME

(71) Applicant: HON HAI PRECISION INDUSTRY CO., LTD., New Taipei (TW)

(72) Inventor: Chih-Huang WU, New Taipei (TW)

(73) Assignee: HON HAI PRECISION INDUSTRY CO., LTD., New Taipei (TW)

(21) Appl. No.: 14/097,253

(22) Filed: Dec. 5, 2013

(30) Foreign Application Priority Data
Apr. 22, 2013 (TW) 102114160

(51) Int. Cl. G06F 13/38; G06F 13/40

(52) U.S. Cl. CPC G06F 13/385; G06F 13/4068
USPC 710/300

(57) ABSTRACT

A serial attached SCSI (SAS) expander includes a first port used to connect to a port of a computer, a second port used to electrically connect to corresponding hard disks. Several third ports are respectively used to connect to one corresponding adjacent SAS expander, a firmware, and a transmission management module. The firmware stores a register value reflecting data traffic of the SAS expander. The transmission management module obtains the register value from the firmware, and determines whether the data traffic of the SAS expander is greater than a predetermined value according to the register value. In addition, distributes a part of data to at least one adjacent SAS expander and then transmits the part of data via the at least one adjacent SAS expander, when determining the data traffic of the SAS expander is greater than the predetermined value.

### BACKGROUND

1. Technical Field

The present disclosure relates to expanders, particularly, to a serial attached SCSI expander and an electronic device with the serial attached SCSI expander.

2. Description of Related Art

Serial attached SCSI (SAS) expanders are widely used in computers. Usually, the computer can connect to a large number of hard disks via a limited number of SAS expanders, each expander is connected between the computer and corresponding number of hard disks, such as sixteen hard disks, and each SAS expander transmits data between the computer and the corresponding hard disks. The hard disks can be taken as external memory devices of the computer or internal memory chips of the computer via the SAS expander. Because one SAS expander usual connects with many hard disks, when the data traffic is greater, the access speed might be very slow. The usual method to resolve the problem is to use a SAS expander with better performance, however, the cost would be increased.

A new SAS expander and an interface expanding device to overcome the described limitations are thus needed.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of an interface expanding device, in accordance with an exemplary embodiment.

FIG. 2 is a block diagram of a SAS expander of the interface expanding device of FIG. 1, in accordance with an exemplary embodiment.

### DETAILED DESCRIPTION

Embodiments of the present disclosure will be described with reference to the accompanying drawings. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

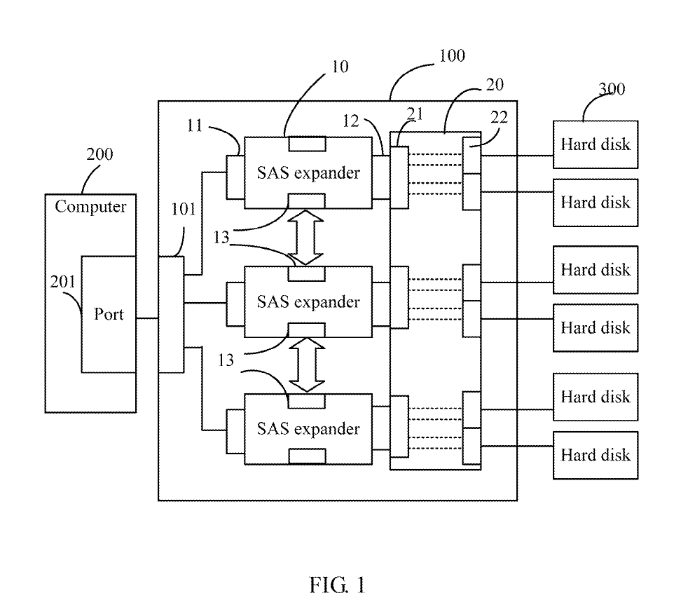

FIG. 1 illustrates an interface expanding device 100. The interface expanding device 100 is connected between a port 201 of a computer 200 and a number of hard disks 300. In the embodiment, the computer 200 can be a desktop computer, a tablet computer, a portable computer, a server, for example. The port 201 can be an external port of the computer 200, such as a universal serial bus (USB) port. The port 201 also can be an internal port of the computer 200, such as a peripheral component interface express (PCIE) port.

The interface expanding device 100 includes a number of serial attached SCSI (SAS) expanders 10 and a computer connection port 101. Each SAS expander 10 includes a first port 11, a second port 12, and several third ports 13. The computer connection port 101 is used to connect to the port 201 of the computer 200. The first ports 11 of all SAS expanders 10 are connected to the computer connection port 101, then, when the computer connection port 101 is connected to the port 201 of the computer 200, the first ports 11 of all of SAS expanders 10 are connected to the port 201 of the computer 200. In another embodiment, the computer connection port 101 can be omitted, and the first ports 11 of all of the SAS expanders 10 are connected to the port 201 of the computer 200 directly.

The second port 12 of each SAS expander 10 is used to electrically connect to corresponding hard disks 300.

In the embodiment, the interface expanding device 100 also includes a connector 20. The connector 20 includes a number of expander connection ports 21 and a number of hard disk connection ports 22. Each expander connection port 21 is connected to the first port 11 of one of the SAS expanders 10. Each hard disk connection port 22 is used to connect to one corresponding hard disk 300. As shown in FIG. 1, in the embodiment, each expander connection port 21 is connected to a number of hard disk connection ports 22. Therefore, each SAS expander 10 is connected to a number of hard disks 300 via the connector 20.

In another embodiment, the connector of the interface expanding device 100 can be omitted, the second port 12 of each SAS expander 10 is connected to a number of hard disks 300 directly.

Each SAS expander 10 is connected to at least one adjacent SAS expander 10 via a corresponding third port 13. In details, each two adjacent SAS expanders 10 establish a number of physical links via the corresponding third ports 13, such as eight physical links. In the embodiment, the number of the third ports 13 of each SAS expander 10 is two. Therefore, the SAS expanders 10 of the interface expanding device 100 are connected in series via the two third ports 13 of each SAS expander 10.

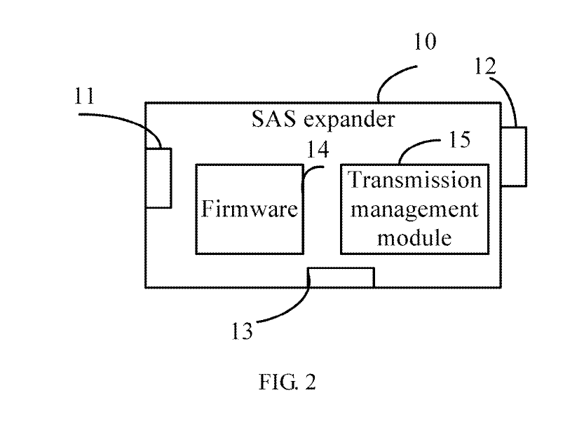

FIG. 2 shows that each SAS expander 10 also includes a piece of firmware 14 and a transmission management module 15. The firmware 14 stores a register value reflecting data traffic of the SAS expander 10 with the firmware 14. When the data traffic of the SAS expander 10 is changed, the register value is changed also.

The transmission management module 15 is used to obtain the register value from the firmware 14, and determine whether the data traffic of the SAS expander 10 is greater than a predetermined value (such as, 100 megabytes) according to the register value. The transmission management module 15 is also used to distribute a part of data to at least one adjacent SAS expander 10 and then transmit the part of data via the at least one adjacent SAS expander 10, when determining the data traffic of the SAS expander 10 is greater than the predetermined value. In detail, if the SAS expander 10 is connected to two adjacent SAS expanders 10 respectively via two third ports 13 of the SAS expander 10. As such, the SAS expander 10 can distribute the part of data to one of the two adjacent SAS expanders 10 or the two adjacent SAS expanders 10.

In the embodiment, the transmission management module 15 can be a processing unit, such as a single chip, a digital signal processor, for example. In another embodiment, the transmission management module 15 also can be a program burned in each SAS expander 10.

In the embodiment, the first ports 11 of all of the SAS expanders 10 have the same address, and the address is directed to the port 201 of the computer 200. The transmission management module 15 distributes a part of data to the at least one adjacent SAS expander 10 and then transmits the part of data via the at least one adjacent SAS expander 10. In detail, the transmission management module 15 produces a distributing request to the at least one adjacent SAS expander 10 via the third port 13, and transmits the part of data to the at least one adjacent SAS expander 10. The transmission management module 15 of the at least one adjacent SAS expander 10 receives the distributing request and transmits the received data to the port 201 of the computer 200 according to the address of the first port 11 of the current SAS expander 10.

In this disclosure, because all of the SAS expanders 10 are connected to the port 201 of the computer 200, the hard disks 300 can transmit data to the port 201 of the computer 200 via any of the SAS expanders 10. Thus, the SAS expander 10 whose data traffic is greater than the predetermined value can distribute the data to the adjacent SAS expander 10 and transmit the data to the computer 200 via the adjacent SAS expander 10, which enhances the access speed without employing another SAS expander with better performance, thereby decreasing the cost.

In the illustrated embodiment, the first port 11, the second port 12, and the third port 13 of each SAS expander 10, and the expander connection port 21 and the hard disk connection port 22 of the connector 20 are independent ports. In another embodiment, the first port 11, the second port 12 and the third port 13 of each SAS expander 10 are different pins of one integrated port, such as different pins of a gold finger. The expander connection port 21 and the hard disk connection port 22 of the connector 20 also are different pins of one integrated port, such as different pins of a gold finger.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An interface expanding device, configured to connect a port of a computer with a plurality of hard disks, comprising:
a computer connection port configured to connect to the port of the computer; and
a plurality of serial attached SCSI (SAS) expanders, wherein, each SAS expander comprises:
a first port configured to connect to the port of the computer via the computer connection port;
a second port configured to electrically connect to a corresponding hard disk;
several third ports configured to respectively connect to one corresponding adjacent SAS expander;
a piece of firmware storing a register value reflecting data traffic of the SAS expander; and
a transmission management module configured to obtain the register value from the firmware, and determine whether the data traffic of the SAS expander is greater than a predetermined value according to the register value; and further configured to distribute a part of data to at least one adjacent SAS expander and then transmit the part of data via the at least one adjacent SAS expander, when determining the data traffic of the SAS expander is greater than the predetermined value.

2. The interface expanding device according to claim 1, wherein each two adjacent SAS expanders establish a plurality of physical links via the corresponding third ports, and the SAS expanders of the interface expanding device are connected in series via the corresponding third ports.

3. The interface expanding device according to claim 1, further comprising a connector, wherein the connector comprises a plurality of expander connection ports and a plurality of hard disk connection ports; each expander connection port is connected to the first port of one of the SAS expanders, each hard disk connection port is configured to connect to one corresponding hard disk, and each expander connection port is connected to a plurality of hard disk connection ports.

4. The interface expanding device according to claim 1, wherein the first ports of all of the SAS expander have the same address, and the address is directed to the port of the computer; the transmission management module distributes the part of data to the at least one adjacent SAS expander and then transmit the part of data via the adjacent SAS expander is: the transmission management module produces a distributing request to the at least one adjacent SAS expander via the third port, and transmits the part of data to the at least one adjacent SAS expander; the transmission management module of the at least one adjacent SAS expander receives the distributing request and transmits the received data to the port of the computer according to the address of the first port of the current SAS expander.

5. The interface expanding device according to claim 1, wherein the port of the computer is an external port of the computer or an internal port of the computer.

6. The interface expanding device according to claim 5, wherein the computer is one selected from a group consisting of a desktop computer, a tablet computer, a portable computer, and a server.

7. The interface expanding device according to claim 3, wherein, the first port, the second port, and the third port of each SAS expander, and the expander connection ports and the hard disk connection ports of the connector are independent ports.

8. The interface expanding device according to claim 3, wherein, the first port, the second port, and the third port of each SAS expander are different pins of one integrated port, and the expander connection ports and the hard disk connection ports of the connector are different pins of another integrated port.

9. A serial attached SCSI (SAS) expander comprising:
a first port configured to connect to a port of a computer;
a second port configured to electrically connect to corresponding hard disks;
several third ports respectively configured to connect to one corresponding adjacent SAS expander;
a piece of firmware storing a register value reflecting data traffic of the SAS expander; and
a transmission management module configured to obtain the register value from the firmware, and determine whether the data traffic of the SAS expander is greater than a predetermined value according to the register value; and further configured to distribute a part of data to at least one adjacent SAS expander and then transmit the part of data via the at least one adjacent SAS expander, when determining the data traffic of the SAS expander is greater than the predetermined value.

10. The SAS expander according to claim 9, wherein each two adjacent SAS expanders establish a plurality of physical links via the corresponding third ports.

11. The SAS expander according to claim 9, wherein the first port, the second port, and the third ports of the SAS expander are independent ports.

12. The SAS expander according to claim 9, wherein the first port, the second port, and the third ports of the SAS expander are different pins of one integrated port.
